(19) United States
(12) Patent Application Publication
(10) Pub. No.: US 2013/0081761 A1
(43) Pub. Date: Apr. 4, 2013

(54) RADICAL PASSING DEVICE AND SUBSTRATE PROCESSING APPARATUS

(71) Applicant: Tokyo Electron Limited, Tokyo (JP)

(72) Inventor: Ikuo Sawada, Austin, TX (US)

(73) Assignee: Tokyo Electron Limited, Tokyo (JP)

(21) Appl. No.: 13/628,705

(22) Filed: Sep. 27, 2012

(30) Foreign Application Priority Data
Sep. 29, 2011 (JP) 2011-215146
Mar. 29, 2012 (JP) 2012-076348

(51) Int. Cl. H05H 1/24; B44C 1/22

(52) U.S. Cl. 156/345.3

(57) ABSTRACT

A radical passing device can selectively pass only radicals from plasma securely. In a chamber 11 of a substrate processing apparatus 10, a radical filter 14 provided between a wafer W mounted on a mounting table 12 and a plasma generator 13 includes a upper shield plate 17 and a lower shield plate 18 positioned opposite to the plasma generator 13 with the upper shield plate 17 therebetween. Further, the upper shield plate 17 has a multiple number of upper through holes 17a formed in a thickness direction thereof, and the lower shield plate 18 has a multiple number of lower through holes 18a formed in a thickness direction thereof. Furthermore, a negative DC voltage is applied to the upper shield plate 17, and a positive DC voltage is applied to the lower shield plate 18.

### CROSS-REFERENCE TO RELATED APPLICATION

This application claims the benefit of Japanese Patent Application Nos. 2011-215146 and 2012-076348 filed on Sep. 29, 2011 and Mar. 29, 2012, respectively, the disclosures of which are incorporated herein by reference.

### FIELD OF THE INVENTION

The present disclosure relates to a radical passing device configured to selectively pass only radicals from plasma and also relates to a substrate processing apparatus.

### BACKGROUND OF THE INVENTION

In a plasma process such as a dry etching process or a film forming process using radicals, if positive ions reach a substrate, a film on the substrate may be sputtered and damaged by the positive ions. To solve this problem, conventionally, there has been developed a device capable of selectively passing only radicals from plasma. As such a device, there is known a plasma processing apparatus, in which two plates are provided between a plasma source and a substrate, and through holes are formed through the two plates such that through holes of one plate are not overlapped with through holes of the other plate when the two plates are placed with a space therebetween (see, for example, Patent Document 1).

In general, since positive ions are attracted by a bias voltage generated in a susceptor that mounts thereon a substrate, the positive ions move straightly. On the other hand, since radicals are electrically neutral, the radicals move randomly without being attracted by the bias voltage. Accordingly, if the through holes of the one plate are arranged without being overlapped with the through holes of the other plate, the positive ions having passed through the through holes of the one plate may collide with the other plate and cannot pass through the through holes of the other plate. Since, however, the radicals do not move straightly, the radicals having passed through the through holes of the one plate may also pass through the through holes of the other plate. As a result, it may be possible to selectively pass only the radicals from the plasma.

Patent Document 1: Japanese Patent Laid-open Publication No. 2006-086449

Recently, however, if high density plasma is generated from a plasma source in order to improve efficiency of a plasma process using radicals, density of positive ions also increases. As a result, a possibility that some of the positive ions pass through both of the aforementioned two plates may be also increased, so that, the film on the substrate may be damaged by the positive ions.

### BRIEF SUMMARY OF THE INVENTION

In view of the foregoing problem, illustrative embodiments provide a radical passing device capable of selectively passing only radicals from plasma more securely and also provide a plasma processing apparatus.

In accordance with one aspect of an illustrative embodiment, there is provided a radical passing device for selectively passing radicals from plasma. The radical passing device includes a first shielding plate; and a second shielding plate positioned opposite to a plasma source with the first shielding plate therebetween. The first shielding plate may have a multiple number of first through holes formed in a thickness direction thereof, and the second shielding plate may have a multiple number of second through holes formed in a thickness direction thereof. Further, a first DC voltage may be applied to the first shielding plate, and a second DC voltage may be applied to the second shielding plate. Furthermore, a polarity of the first DC voltage may be different from a polarity of the second DC voltage.

In the radical passing device, the first shielding plate and the second shielding plate may be arranged such that the second through holes are not seen through the first through holes when viewed from the first shielding plate.

Further, a maximum width of each through hole may be set to be equal to or smaller than about twice a thickness of a sheath generated on a surface of the first shielding plate.

The polarity of the first DC voltage and the polarity of the second DC voltage may be variable.

Here, the polarity of the first DC voltage may be negative.

The first shielding plate and an electrode plate to which a high frequency power is applied may be arranged in parallel with each other to serve as a pair of parallel plate electrodes.

The radical passing device may be provided to surround a processing space between the plasma source and a mounting table for mounting thereon a substrate.

In accordance with another aspect of the illustrative embodiment, there is provided a substrate processing apparatus having a chamber for accommodating therein a substrate on which a plasma process is performed; a plasma source; and a radical passing device that is provided in the chamber and selectively passes radicals from plasma. The radical passing device may include a first shielding plate provided between the plasma source and the substrate; and a second shielding plate positioned opposite to the plasma source with the first shielding plate therebetween. Further, the first shielding plate may have a multiple number of first through holes formed in a thickness direction thereof, and the second shielding plate may have a multiple number of second through holes formed in a thickness direction thereof. Furthermore, a first DC voltage may be applied to the first shielding plate, and a second DC voltage may be applied to the second shielding plate. Moreover, a polarity of the first DC voltage may be different from a polarity of the second DC voltage.

In accordance with still another of the illustrative embodiment, there is provided a substrate processing apparatus having a chamber for accommodating therein a substrate on which a plasma process is performed; a mounting table that is provided in the chamber, mounts thereon the substrate and serves as an electrode; and a facing electrode that is disposed in the chamber to face the mounting table and connected to a high frequency power supply. Further, the substrate processing apparatus includes a first shielding plate facing a processing space between the mounting table and the facing electrode; and a second shielding plate disposed opposite to the processing space with the first shielding plate therebetween. The first shielding plate may have a multiple number of first through holes formed in a thickness direction thereof, and the second shielding plate may have a multiple number of second through holes formed in a thickness direction thereof. A first DC voltage may be applied to the first shielding plate, and a second DC voltage may be applied to the second shielding plate. Moreover, a polarity of the first DC voltage may be different from a polarity of the second DC voltage. Furthermore, the first shielding plate may be connected to a first impedance adjusting circuit, and the mounting table may be connected to a second impedance adjusting circuit. When a high frequency current caused by a high frequency power applied from the high frequency power supply flows in the processing space, the first impedance adjusting circuit may control the high frequency current flowing toward the first shielding plate and the second impedance adjusting circuit may control the high frequency current flowing toward the mounting table.

In the substrate processing apparatus, the first shielding plate and the second shielding plate may be arranged to surround the processing space.

In accordance with the illustrative embodiment, the polarity of the first DC voltage applied to the first shielding plate is different from the polarity of the second DC voltage applied to the second shielding plate that is positioned opposite to the plasma source with the first shielding plate therebetween. By way of example, when the polarity of the first DC voltage is negative and the polarity of the second DC voltage is positive, the positive ions facing the portions of the first shielding plate other than the first through holes are attracted toward the first shielding plate, electrically neutralized, and stay on the first shielding plate. Meanwhile, the positive ions facing the first through holes are repelled back from the second shielding plate by the repulsive force after passing through the first through holes. Accordingly, it is possible to prevent the positive ions from passing through the second through holes. Further, electrons facing the portions of the first shielding plate other than the first through holes are repelled back from the first shielding plate by the repulsive force. Meanwhile, electrons facing the first through holes are attracted toward the second shielding plate and disappeared after passing through the first through holes. Further, when the polarity of the first DC voltage is positive and the polarity of the second DC voltage is negative, the electrons facing the portions of the first shielding plate other than the first through holes are attracted toward the first shielding plate and disappeared. Meanwhile, the electrons facing the first through holes are repelled back from the second shielding plate after passing through the first through holes. Accordingly, it is possible to prevent the electrons from passing through the second through holes. Further, the positive ions facing the portions of the first shielding plate other than the first through holes are repelled back from the first shielding plate by the repulsive force. Meanwhile, the positive ions facing the first through holes are attracted toward the second shielding plate, electrically neutralized, and stay on the second shielding plate after passing through the first shielding plate. Accordingly, it is possible to prevent the positive ions and the electrons in the plasma from passing through the radical passing device. Meanwhile, since the radicals in the plasma are electrically neutral, the radicals are attracted toward neither the first shielding plate nor the second shielding plate. Further, the radicals are not affected by the repulsive force from the first shielding plate or the second shielding plate. As a result, the plasma can be confined and it is possible to selectively pass only the radicals from the plasma through the first and second shielding plates securely.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a cross sectional view schematically illustrating a configuration of a substrate processing apparatus in accordance with an illustrative embodiment;

FIG. 2 is a partially enlarged plane view showing a positional relationship between upper through holes and lower through holes when a radical filter is viewed from a direction of a white arrow in FIG. 1;

FIG. 3 provides partially enlarged views of the radical filter for describing an electrostatic force effect, FIGS. 3(A) and 3(B) illustrate cases of applying a negative DC voltage to an upper shield plate and applying a positive DC voltage to a lower shield plate, and FIGS. 3(C) and 3(D) illustrate cases of applying the positive DC voltage to the upper shield plate and applying the negative DC voltage to the lower shield plate;

FIG. 4 is an partially enlarged cross sectional view of the radical filter for describing a state of a sheath generated on a surface of the upper shield plate and on a sidewall of the upper through hole in FIG. 1;

FIG. 5 provides partially enlarged views of the radical filter for describing a Lorentz force effect on plasma that has entered a space between the upper shield plate and the lower shield plate, FIG. 5(A) is a diagram showing movements of positive ions in the plasma between the upper shield plate and the lower shield plate, and FIG. 5(B) is a diagram showing movements of electrons between the upper shield plate and the lower shield plate;

FIG. 6 is a cross sectional view schematically illustrating a first modification example of the substrate processing apparatus of FIG. 1;

FIG. 7 is a cross sectional view schematically illustrating a second modification example of the substrate processing apparatus of FIG. 1;

FIG. 8 is a cross sectional view schematically illustrating a third modification example of the substrate processing apparatus of FIG. 1;

FIG. 9 is a cross sectional view schematically illustrating a fourth modification example of the substrate processing apparatus of FIG. 1;

FIG. 10 is a cross sectional view schematically illustrating a fifth modification example of the substrate processing apparatus of FIG. 1;

FIG. 11 provides modification examples of an LC circuit in the fourth and fifth modification examples, FIG. 11(A) shows a parallel type LC circuit, FIG. 11(B) shows a n-type LC circuit, and FIG. 11(C) shows a T-type LC circuit; and

FIG. 12 is a cross sectional view schematically illustrating a sixth modification example of the substrate processing apparatus of FIG. 1.

### DETAILED DESCRIPTION OF THE INVENTION

Hereinafter, an illustrative embodiment will be described with reference to the accompanying drawings.

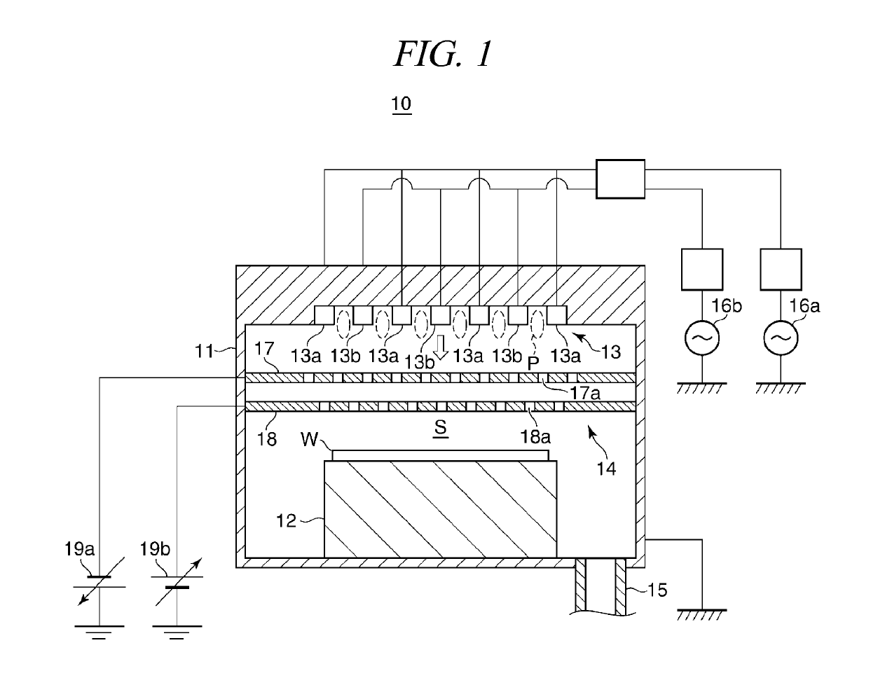

FIG. 1 is a cross sectional view schematically illustrating a configuration of a substrate processing apparatus in accordance with the illustrative embodiment.

In FIG. 1, a substrate processing apparatus 10 includes a cylindrical chamber 11 (accommodation chamber) for accommodating therein a wafer W as a substrate; a mounting table 12 for mounting thereon the wafer W; a plasma generator 13 as a plasma source; a radical filter 14 (radical passing device); a non-illustrated processing gas supplying unit; and an exhaust pipe 15. The chamber 11 is grounded, and the mounting table 12 is provided at a bottom portion of the chamber 11. The plasma generator 13 is disposed at a ceiling portion of the chamber 11, facing the mounting table 12. The radical filter 14 is disposed in a processing space S between the mounting table 12 and the plasma generator 13. The non-illustrated processing gas supplying unit introduces a processing gas toward the processing space S, and the exhaust pipe 15 exhausts a gas within the chamber 11 including the processing space S.

The substrate processing apparatus 10 generates plasma from the introduced processing gas by the plasma generator 13 and forms a crystalline film such as a GaN epitaxial film on the wafer W by using radicals in the plasma.

The plasma generator 13 is an electrode including a multiple number of first and second conductors 13a and 13b. Each of the first conductors 13a and each of the second conductors 13b are alternately positioned with groove-shaped space therebetween. The first conductors 13a are connected to a first high frequency power supply 16a, and the second conductors 13b are connected to a second high frequency power supply 16b. The second conductors 13b are arranged between the first conductors 13a. Since the second high frequency power supply 16b applies a high frequency power having an opposite phase to that of a high frequency power applied from the first high frequency power supply 16a, the phases of the high frequency powers applied to the adjacent first and second conductors 13a and 13b are opposite. Accordingly, an electric field is formed between the first and second conductors 13a and 13b, and plasma P is generated from the processing gas by the electric field. As a result, the plasma P is generated between the adjacent first and second conductors 13a and 13b in the plasma generator 13.

The radical filter 14 includes an upper shield plate 17 (first shielding plate) disposed to face the plasma generator 13; and a lower shield plate 18 (second shielding plate) positioned opposite to the plasma generator 13 with the upper shield plate 17 positioned therebetween. Both of the upper shield plate 17 and the lower shield plate 18 are made of a conductor such as aluminum.

As for the upper shield plate 17 and the lower shield plate 18, it is desirable that at least their surfaces in contact with the radicals are coated with a dielectric material such as ceramic (e.g., alumina). By coating the dielectric material on the plates 17 and 18, it is possible to prevent the radicals from contacting with the conductors. As a result, the radicals can be prevented from being deactivated. When performing the coating, a conventional method such as thermal spraying may be used. As will be described later, DC voltages are applied to the upper shield plate 17 and the lower shield plate 18 when using an electrostatic force effect in order to selectively pass only the radicals through the shield plates. In such a case, if the coating thickness is too thick, the electric field would be weakened so that the electrostatic force effect may also be reduced. Thus, the coating thickness needs to be set so as not to reduce the electrostatic force effect.

Further, in accordance with the present illustrative embodiment, the upper shield plate 17 and the lower shield plate 18 are arranged in parallel with each other. The upper shield plate 17 has a multiple number of upper through holes 17a (first through holes) formed in a thickness direction thereof. The lower shield plate 18 has a multiple number of lower through holes 18a (second through holes) formed in a thickness direction thereof.

The upper shield plate 17 is connected to a first DC power supply 19a that applies a negative DC voltage to the upper shield plate 17. The lower shield plate 18 is connected to a second DC power supply 19b that applies a positive DC voltage to the lower shield plate 18.

Further, the manner for applying the DC voltages to the upper shield plate 17 and the lower shield plate 18 may not be limited to the above example, but the DC voltages having different polarities may be applied to the upper shield plate 17 and the lower shield plate 18, respectively. By way of example, the positive DC voltage may be applied to the upper shield plate 17, and a negative DC voltage is applied to the lower shield plate 18.

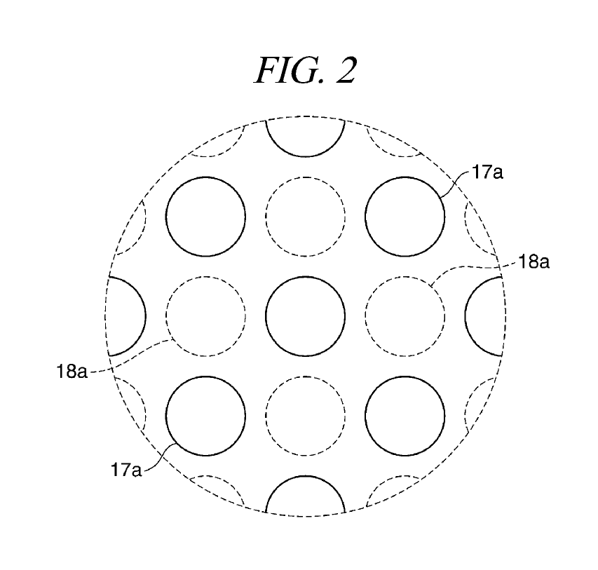

FIG. 2 is a partially enlarged plane view showing a positional relationship between the upper through holes 17a and the lower through holes 18a when the radical filter 14 is viewed from the direction of a white arrow of FIG. 1.

When the radical filter 14 is viewed from the upper shield plate 17, positions of the upper through holes 17a and positions of the lower through holes 18a are not overlapped, and the lower through holes 18a cannot be seen through the upper through holes 17a, as illustrated in FIG. 2. That is, particles passing through the upper through holes 17a in a direction substantially perpendicular to the upper shield plate 17 collide with the lower shield plate 18. Further, although the plasma P also emits light such as an ultraviolet ray that may damage a film on the wafer W, such light can also be blocked by the lower shield plate 18 after passing through the upper through holes 17a in this radical filter 14.

In accordance with the present illustrative embodiment, the radical filter 14 allows only radicals from the plasma P to pass therethrough by three effects (electrostatic force effect, sheath effect, and Lorentz force effect) to be described later.

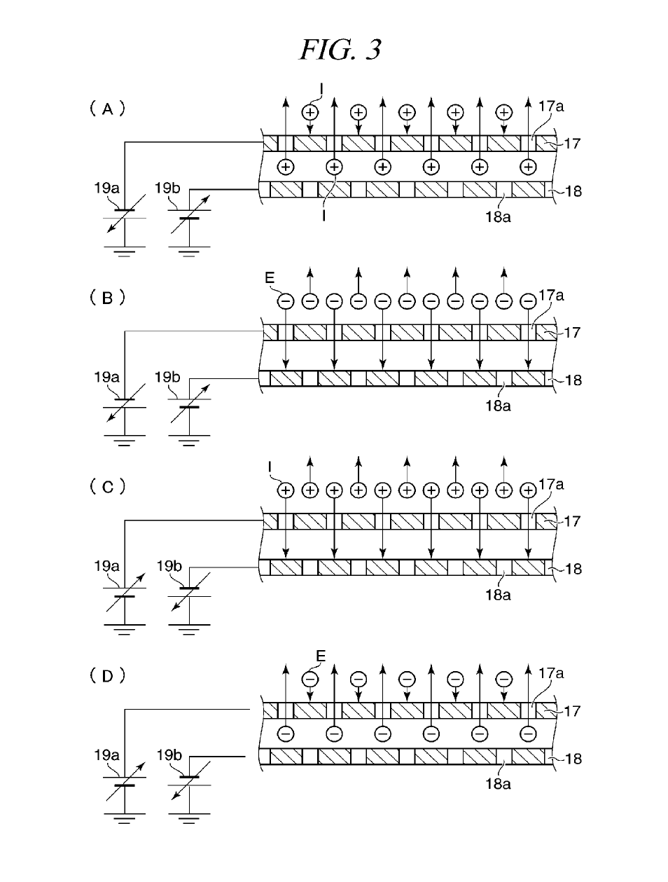

First, the electrostatic force effect will be described with reference to FIGS. 3(A) to 3(D).

For example, if the first DC power supply 19a applies a negative DC voltage to the upper shield plate 17 and the second DC power supply 19b applies a positive DC voltage to the lower shield plate 18, a polarity of positive ions I in the plasma P facing portions of the upper shield plate 17 other than the upper through holes 17a is different from a polarity of the DC voltage applied to the upper shield plate 17. Accordingly, the positive ions I are attracted toward the upper shield plate 17 by an electrostatic force. Then, if the positive ions I collide with the upper shield plate 17, the positive ions I are captured by the upper shield plate 17 so that the positive ions I are electrically neutralized and stay on the upper shield plate 17. Further, even if the positive ions I are not captured but bounced on the surface of the upper shield plate 17, the positive ions I are not attracted toward the wafer W again by the electrostatic force caused by the electric field because the positive ions I have been already electrically neutralized and have lost electric charges. Thus, the film on the wafer W is not damaged by the positive ions I. Furthermore, the polarity of the positive ions I facing the upper through holes 17a is the same as the polarity of the DC voltage applied to the lower shield plate 18. Accordingly, if some of the positive ions I pass through the upper through holes 17a without colliding with the upper shield plate 17, the positive ions I would be repelled back toward the upper shield plate 17 from the lower shield plate 18 by a repulsive force caused by the electrostatic force. As a result, the positive ions I cannot pass through the lower through holes 18a of the lower shield plate 18 (FIG. 3(A)).

Meanwhile, a polarity of electrons E in the plasma P facing the portions of the upper shield plate 17 other than the upper through holes 17a is the same as the polarity of the DC voltage applied to the upper shield plate 17. Accordingly, the electrons E are repelled back toward the plasma generator 13 from the upper shield plate 17 by the repulsive force caused by the electrostatic force. Further, since the polarity of the electrons E facing the upper through holes 17a is different from the DC voltage applied to the lower shield plate 18, these electrons E may be attracted toward the lower shield plate 18 by the electrostatic force after passing through the upper through holes 17a. Then, if these electrons E collide with the lower shield plate 18, they are electrically neutralized and disappeared (FIG. 3(B)).

Further, by way of example, if the first DC power supply 19a applies a positive DC voltage to the upper shield plate 17 and the second DC power supply 19b applies a negative DC voltage to the lower shield plate 18, the polarity of the positive ions I facing the portions of the upper shield plate 17 other than the upper through holes 17a is the same as the polarity of the DC voltage applied to the upper shield plate 17. Accordingly, the positive ions I are repelled back toward the plasma generator 13 from the upper shield plate 17 by the repulsive force caused by an electrostatic force. Further, since the polarity of the positive ions I facing the upper through holes 17a is different from the polarity of the DC voltage applied to the lower shield plate 18, these positive ions I are attracted toward the lower shield plate 18 by the electrostatic force after passing through the upper through holes 17a. Then, if these positive ions I collide with the lower shield plate 18, the positive ions I are captured by the lower shield plate 18 so that the positive ions I are electrically neutralized and stay on the lower shield plate 18 (FIG. 3(C)).

Meanwhile, the polarity of the electrons E facing the portions of the upper shield plate 17 other than the upper through holes 17a is different from the polarity of the DC voltage applied to the upper shield plate 17. Accordingly, the electrons E are attracted toward the upper shield plate 17 by the electrostatic force. Then, if the electrons E collide with the upper shield plate 17, the electrons E are electrically neutralized and disappeared. Further, since the polarity of the electrons E facing the upper through holes 17a is the same as the polarity of the DC voltage applied to the lower shield plate 18, these electrons E are repelled back toward the upper shield plate 17 from the lower shield plate 18 by the repulsive force caused by the electrostatic force after passing through the upper through holes 17a. As a result, the electrons E cannot pass through the lower through holes 18a of the lower shield plate 18 (FIG. 3(D)).

Accordingly, if the polarity of the DC voltage applied to the upper shield plate 17 is set to be different from the polarity of the DC voltage applied to the lower shield plate 18, it is possible to prevent the positive ions I and the electrons E in the plasma P from passing through the radical filter 14.

Meanwhile, since the radicals in the plasma P are electrically neutral, the radicals are attracted toward neither the upper shield plate 17 nor the lower shield plate 18. Further, the radicals are not affected by the repulsive force caused by the electrostatic force from the upper shield plate 17 or the lower shield plate 18. As a result, it is possible to selectively pass only the radicals from the plasma P.

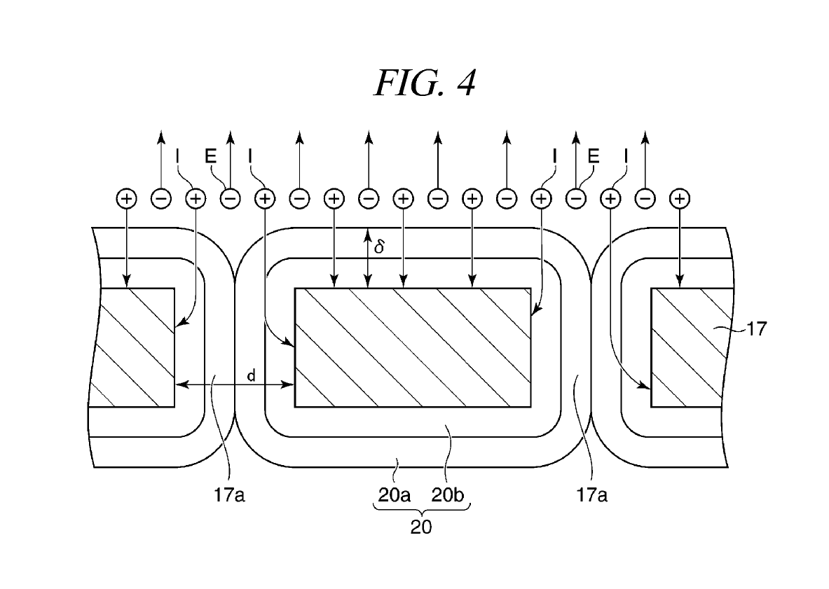

Now, the sheath effect will be described with reference to FIG. 4.

Typically, since a sheath accompanying an electric field is generated on the surface of an object facing plasma, a sheath is also generated on the surface of the conductor forming the upper shield plate 17. The sheath serves as an ionosphere in space. The positive ions are accelerated toward the conductors by the electric field in the sheath, whereas the electrons are accelerated away from the conductors by this electric field. By applying a negative electric potential to the conductor, a thickness of the sheath can be increased. Although a gradient of a space potential rapidly changes at an interface between the sheath and the plasma, typically, a sheath region ranging from the surface of the object to the interface between the sheath and the plasma is defined as a sheath thickness. Simply, between the surface of the object and the plasma that emits light, a region in which light emission is remarkably weak is regarded as a sheath.

In accordance with the present illustrative embodiment, by applying a negative DC voltage to the upper shield plate 17 from the first DC power supply 19a, the thickness of the sheath generated on the surface of the upper shield plate 17 can be increased.

FIG. 4 is an partially enlarged cross sectional view of the radical filter 14 for describing a state of the sheath generated on the surface of the upper shield plate 17 and on a sidewall of the upper through hole 17a in FIG. 1.

In FIG. 4, a sheath 20 is generated on the surface of the upper shield plate 17 to which a negative voltage is applied. To elaborate, the sheath 20 includes a first sheath portion 20a generated due to the plasma P generated by the plasma generator 13 and a second sheath portion 20b generated due to the negative DC voltage applied to the upper shield plate 17. Since the thickness of the second sheath portion 20b varies depending on a magnitude of the applied negative DC voltage, the thickness of the sheath 20 can be controlled by adjusting the negative DC voltage applied to the upper shield plate 17.

In accordance with the present illustrative embodiment, the magnitude of the negative DC voltage applied to the upper shield plate 17 is adjusted such that a thickness δ of the sheath 20 is equal to or larger than the half of a maximum width d of the upper through hole 17a. Accordingly, the upper through hole 17a is clogged by the sheath 20 generated on the surface of the upper shield plate 17, more specifically, by the sheath 20 generated on the sidewall of the upper through hole 17a.

Here, the positive ions I that attempt to enter the upper through hole 17a are accelerated by the sheath 20 toward the sidewall of the upper through hole 17a and attracted toward the sidewall of the upper through hole 17a. Meanwhile, the electrons E that attempt to enter the upper through hole 17a are accelerated away from the upper shield plate 17 by the sheath 20 and repelled against the upper through hole 17a.

Accordingly, by setting the thickness δ of the sheath 20 to be equal to or larger than the half of the maximum width d of the upper through hole 17a, that is, by setting the maximum width d of the upper through hole 17a to be equal to or smaller than about twice the thickness of the sheath 20, it is possible to prevent both of the positive ions I and the electrons E from passing through the upper through hole 17a.

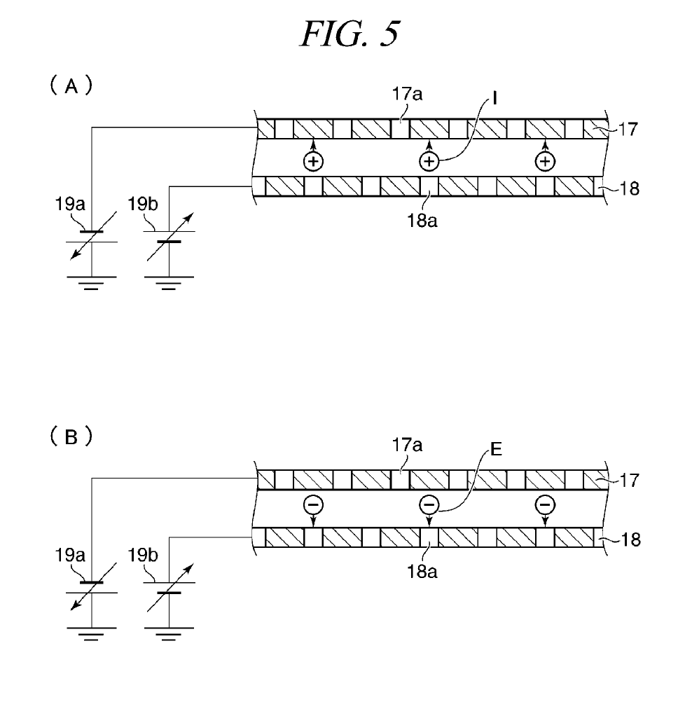

The Lorentz force effect will be described with reference to FIGS. 5(A) and 5(B). Different from the electrostatic force effect and the sheath effect as discussed above, the Lorentz force effect is configured to block plasma that attempts to enter the processing space S after passing through the radical filter 14.

Here, in general, a Lorentz force (F) acting on a particle is expressed by the following Eq. (1).

F=q(E+v×B) Eq. (1)

Here, q denotes an electric charge; E denotes an electric field; v denotes a velocity of the particle; and B denotes a magnetic field. In the present illustrative embodiment, since no magnetic field exists, only the Lorentz force caused by the electric field acts on the particle.

In the radical filter 14, since the DC voltages having different polarities are applied to the upper shield plate 17 and the lower shield plate 18, respectively, an electric field perpendicular to the upper shield plate 17 and the lower shield plate 18 (hereinafter, referred to as a “vertical electric field”) is generated between the upper shield plate 17 and the lower shield plate 18. Here, if the plasma P enters a space between the upper shield plate 17 and the lower shield plate 18 after passing through the upper through holes 17a, the vertical electric field acts on the positive ions I and the electrons E in the plasma that are moving in random direction. As a result, the positive ions I and the electrons E are attracted in certain directions by the Lorentz force. Here, since polarities of the positive ions I and the electrons E are different from each other, the positive ions I and the electrons E are attracted in the opposite directions to each other. That is, the positive ions I are attracted toward the upper shield plate 17, whereas the electrons E are attracted toward the lower shield plate 18. As a result, the plasma P is polarized. In the polarized plasma P, ambipolar diffusion is suppressed so that the positive ions I and the electrons E stay in the space between the upper shield plate 17 and the lower shield plate 18. Accordingly, it is possible to prevent the polarized plasma between the upper shield plate 17 and the lower shield plate 18 from entering the processing space S through the lower through holes 18a of the lower shield plate 18.

As mentioned above, in the present illustrative embodiment, no magnetic field exists. Thus, the case where only the Lorentz force caused by the electric field acts on the particles has been described. If, however, a magnetic field (which is orthogonal to the vertical electric field and has a component parallel with the upper shield plate 17 or the like) is additionally applied, the positive ions I and the electrons E in the plasma P may drift in a direction that is orthogonal to the electric field and the magnetic field and parallel with the upper shield plate 17 or the like, and may also drift in directions opposite to each other. Accordingly, it is possible to effectively prevent the plasma P from entering the processing space S through the lower through holes 18a of the lower shield plate 18.

Meanwhile, since the radicals are electrically neutral, the radicals are not influenced by the Lorentz force caused by the electric field between the upper shield plate 17 and the lower shield plate 18. As a result, it is possible to selectively pass only the radicals through the radical filter 14 securely.

With the radical filter 14 in accordance with the present illustrative embodiment, since a negative DC voltage is applied to the upper shield plate 17 and a positive DC voltage is applied to the lower shield plate 18, the positive ions I or the electrons E can be prevented from passing through the radical filter 14 by the above-described three effects (electrostatic force effect, sheath effect, and Lorentz force effect). Accordingly, the plasma P is confined in the upper portion of the radical filter 14 and only the radicals can be selectively allowed to pass through the radical filter 14.

Further, the plasma P emits an ultraviolet ray, and if this ultraviolet ray reaches a GaN epitaxial film formed on the wafer W, the GaN epitaxial film may be deteriorated. However, the ultraviolet ray emitted from the plasma P cannot pass through the radical filter 14 because the radical filter 14 is configured such that, when the radical filter 14 is viewed from the upper shield plate 17, the lower through holes 18a of the lower shield plate 18 cannot be seen through the upper through holes 17a of the upper shield plate 17. As a result, it is possible to prevent the GaN epitaxial film from being deteriorated by the ultraviolet ray.

In the above-described radical filter 14, DC voltages having different polarities are applied to the upper shield plate 17 and the lower shield plate 18, respectively. Here, it is desirable to vary an absolute value of an electric potential difference between the upper shield plate 17 and the lower shield plate 18 (herein, referred to as an “inter-plate potential difference”) depending on an output of the plasma generator 13.

To elaborate, as the high frequency powers applied to the first and second conductors 13a and 13b increase, the absolute value of the inter-plate potential difference is set to be larger. If the magnitude of the high frequency powers applied to the first and second conductors 13a and 13b are large, a generation amount of the plasma P also becomes increased and, thus, the amounts of the positive ions I and the electrons E also become increased. As a result, the probability that the positive ions I or the electrons E may pass through the radical filter 14 is increased. If, however, the absolute value of the inter-plate potential difference is increased, the electric field generated between the upper shield plate 17 and the lower shield plate 18 becomes intensive, and the Lorentz force acting on the positive ions I or the electrons E reaching the space between the upper shield plate 17 and the lower shield plate 18 is also increased. Besides, since the electric potential difference between the positive ions I and the upper shield plate 17 or the lower shield plate 18 and an electric potential difference between the electrons E and the upper shield plate 17 or the lower shield plate 18 can be increased, the electrostatic force that acts on the positive ions I from the upper shield plate 17 or the lower shield plate 18 and the electrostatic force that acts on the electrons E from the upper shield plate 17 or the lower shield plate 18 can be increased. That is, the above-described Lorentz force effect or the electrostatic force effect can be efficiently utilized. As a result, even if the amount of the positive ions I or the electrons E increases, it is possible to prevent the positive ions I or the electrons E from passing through the radical filter 14.

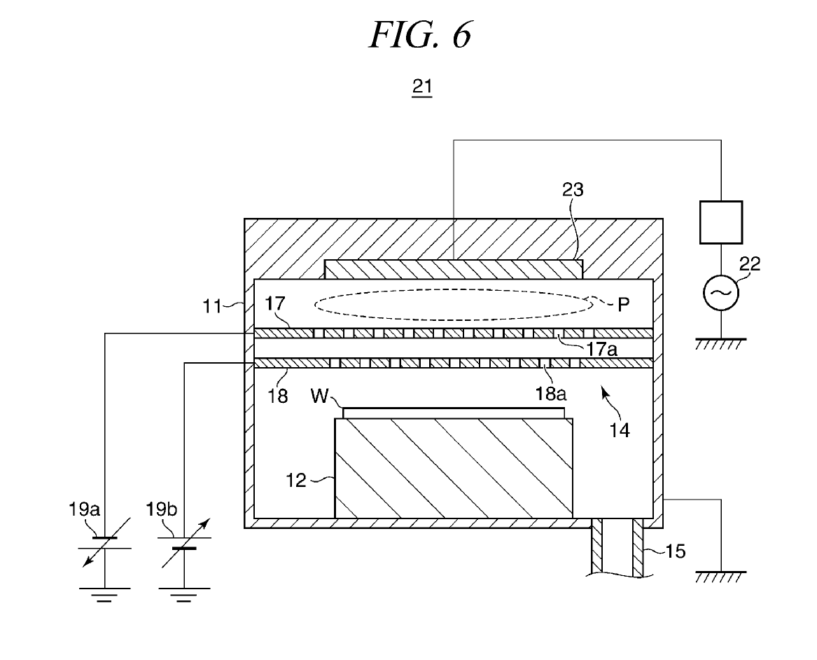

By way of example, the present inventor has observed that if a high frequency power applied to an upper electrode plate 23 is set to be, e.g., about 300 W in a substrate processing apparatus 21 of FIG. 6, the positive ions I or the electrons E pass through the radical filter 14 when the absolute value of the inter-plate potential difference is equal to or smaller than, e.g., about 50 V. However, the inventor has also found out that if the absolute value of the inter-plate potential difference is equal to or larger than, e.g., about 100 V, the positive ions I or the electrons E do not pass through the radical filter 14. Further, if the high frequency power applied to the upper electrode plate 23 is set to be, e.g., about 600 W, the inventor has observed that the positive ions I or the electrons E pass through the radical filter 14 when the absolute value of the inter-plate potential difference is equal to or smaller than about 100 V. However, the inventor has also found out that if the absolute value of the inter-plate potential difference is equal to or larger than, e.g., about 150 V, the positive ions I or the electrons E do not pass through the radical filter 14. Furthermore, if the high frequency power applied to the upper electrode plate 23 is set to be, e.g., about 900 W, the inventor has observed that the positive ions I or the electrons E pass through the radical filter 14 when the absolute value of the inter-plate potential difference is equal to or smaller than about 250 V. However, the inventor has also found out that if the absolute value of the inter-plate potential difference is equal to or larger than, e.g., about 300 V, the positive ions I or the electrons E do not pass through the radical filter 14.

Further, when the inter-plate potential difference is set to be large, if the magnitude of the DC voltage applied to the upper shield plate 17 or the lower shield plate 18 is set to be too large, the positive ions I may be intensively attracted toward the upper shield plate 17 or the lower shield plate 18. As a result, the upper shield plate 17 or the lower shield plate 18 may be damaged by sputtering or secondary electrons E may be emitted from the upper shield plate 17 or the lower shield plate 18. Accordingly, it may be desirable that the negative DC voltage applied to the upper shield plate 17 or the lower shield plate 18 is set to be, e.g., about several tens of volts.

Although either a negative DC voltage or a positive DC voltage can be applied to the upper shield plate 17, it is desirable to apply the negative DC voltage to the upper shield plate 17. By applying the negative DC voltage to the upper shield plate 17, the thickness of the sheath generated on the surface of the upper shield plate 17 can be increased, and the upper through holes 17a can be securely clogged by the sheath. That is, since the positive ions I and the electrons E can be prevented from passing through the upper shield plate 17 that is located farther from the wafer W than the lower shield plate 18, the positive ions I and the electrons E can be more securely prevented from reaching the wafer W.

In addition, the polarities of the DC voltages applied to the upper shield plate 17 and the lower shield plate 18 can be altered with the lapse of time. As a result, it is possible to change the shield plate to which the positive ions I are attracted. Accordingly, it can be prevented that only one shield plate is consumed by the sputtering that occurs when the positive ions I are attracted thereto. Thus, lifetime of the radical filter 14 can be lengthened.

The above-described illustrative embodiment is not intended to be limiting and can be modified in various ways.

In the above-described substrate processing apparatus 10, although the plasma generator 13 having the multiple number of the first and second conductors 13a and 13b is used as a plasma source, the plasma source may not be limited thereto. Another type of plasma source, e.g., parallel plate electrodes may be used as the plasma source.

FIG. 6 is a cross sectional view schematically illustrating a first modification example of the substrate processing apparatus 10 of FIG. 1. In this modification example, parallel plate electrodes are used as the plasma source.

The substrate processing apparatus 21 of FIG. 6 includes the upper electrode plate 23 provided at the ceiling portion of the chamber 11 so as to face the mounting table 12 and made of, e.g., a conductor. The upper electrode plate 23 is provided in parallel with the upper shield plate 17. Further, the upper electrode plate 23 is connected to a high frequency power supply 22 and a high frequency power is applied to the upper electrode plate 23. Here, since a negative DC voltage is applied to the upper shield plate 17, an electric field is generated between the upper electrode plate 23 and the upper shield plate 17, and plasma P is generate by this electric field. That is, the upper electrode plate 23 and the upper shield plate 17 serve as a pair of parallel plate electrodes. With this configuration, it is unnecessary to additionally provide an electrode plate facing the upper electrode plate 23 so as to provide the plasma source in the substrate processing apparatus 21. Thus, the structure of the substrate processing apparatus 21 can be simplified.

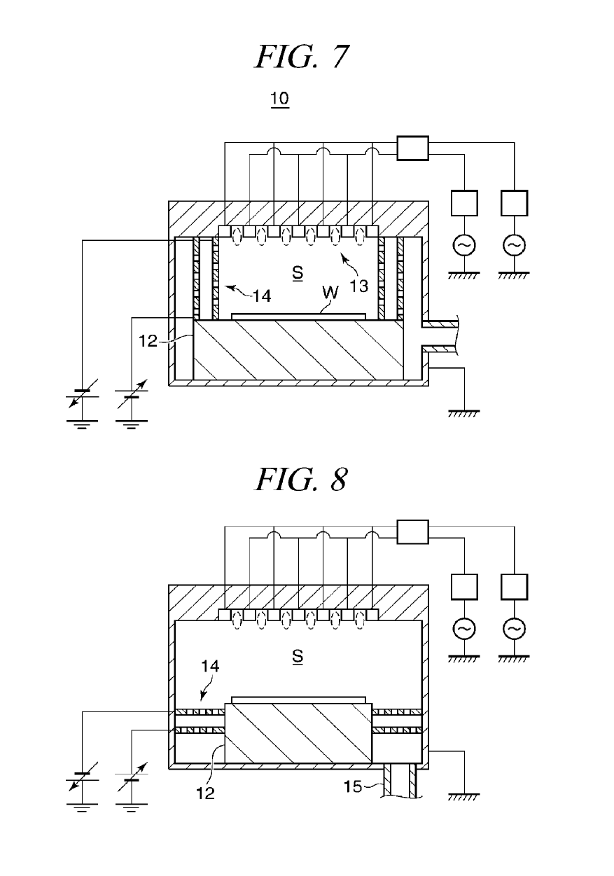

Further, the radical filter 14 may not be provided between the plasma generator 13 and the mounting table 12. Instead, as depicted in FIG. 7, the radical filter 14 may be disposed to surround the processing space S between the plasma generator 13 and the mounting table 12. In this configuration, the radical filter 14 serves as a plasma confining unit. Since the radical filter 14 prevents the positive ions I or the electrons E from passing therethrough, the positive ions I or the electrons E can be confined in the processing space S. Accordingly, since the radical filter 14 disposed to surround the processing space S confines the positive ions I in the processing space S, the density of the positive ions I in the processing space S can be increased. As a result, efficiency of a plasma process such as a dry etching process performed on the wafer W can be improved.

Further, as illustrated in FIG. 8, the radical filter 14 may be disposed to surround a sidewall of the mounting table 12, serving as an exhaust plate. With this configuration, the positive ions I or the electrons E the processing space S can be prevented from entering the exhaust pipe 15, and, thus, damage of an exhaust pump or the like by sputtering of the positive ions I can be prevented.

Furthermore, in the modification examples of the substrate processing apparatus 10 having the radical filter 14 shown in FIGS. 7 and 8, the plasma source is not limited to the plasma generator 13. As in the substrate processing apparatus 21 of FIG. 6, a plasma generating device using the parallel plate electrodes or any other device can be used as the plasma source.

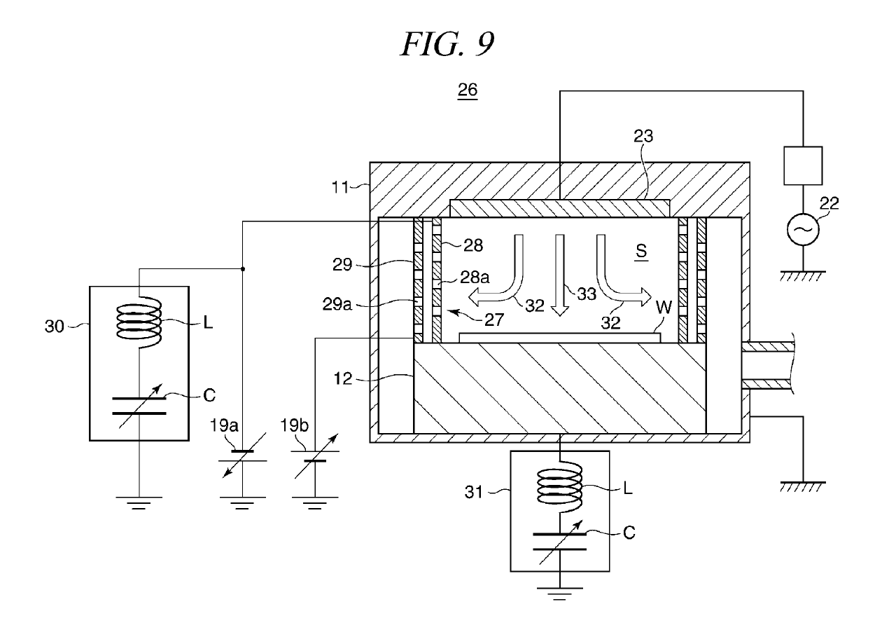

By way of example, as depicted in FIG. 9, when a substrate processing apparatus 26 includes the parallel plate electrodes having the mounting table 12 and the upper electrode plate 23 (facing electrode) that is connected to the high frequency power supply 22, a radical filter 27 may be disposed to surround the processing space S between the upper electrode plate 23 and the mounting table 12.

The radical filter 27 may have a cylindrical inner shield plate 28 (first shielding plate) facing the processing space S; and a cylindrical outer shield plate 29 (second shielding plate) disposed opposite to the processing space S with the inner shield plate 28 therebetween. Both of the inner shield plate 28 and the outer shield plate 29 are made of a conductor, e.g., aluminum.

The inner shield plate 28 and the outer shield plate 29 are coaxially arranged. The inner shield plate 28 has a multiple number of inner through holes 28a (first through holes) formed in a thickness direction thereof. The outer shield plate 29 has a multiple number of outer through holes 29a (second through holes) formed in a thickness direction thereof.

Further, the inner shield plate 28 is connected to the first DC power supply 19a that applies a negative DC voltage to the inner shield plate 28. The outer shield plate 29 is connected to the second DC power supply 19b that applies a positive DC voltage to the outer shield plate 29. Here, alternatively, a positive DC voltage may be applied to the inner shield plate 28, and a negative DC voltage is applied to the outer shield plate 29.

When the radical filter 27 is viewed from the inner shield plate 28, positions of the inner through holes 28a are not overlapped with positions of the outer through holes 29a. That is, the outer through holes 29a cannot be seen through the inner through holes 28a.

With the above-described configuration, the radical filter 27 selectively passes the radicals from the plasma in the processing space S. As a result, like the radical filter 14, the radical filter 27 can confine the plasma P in the processing space S by preventing the positive ions I or the electrons E from escaping from the processing space S.

If, however, the plasma generating device using the parallel plate electrodes is used as the plasma source, the plasma is not distributed uniformly in the processing space between the upper electrode plate and the mounting table serving as a lower electrode. Further, in a central portion of the processing space facing a central portion of the wafer or a central portion of the upper electrode plate, a plasma density becomes higher. In this case, the radical filter 27 may serve as a plasma density distribution controller. In the radical filter 27 serving as the plasma density distribution controller, a first LC circuit 30 (first impedance adjusting circuit) is connected to the inner shield plate 28 in parallel with the first DC power supply 19a. The inner shield plate 28 is grounded via the first LC circuit 30. Further, a second LC circuit 31 (second impedance adjusting circuit) is connected to the mounting table 12, and the mounting table 12 is grounded via the second LC circuit 31.

Each of the first and second LC circuits 30 and 31 includes a coil L and a variable capacitor C that are connected in series. By varying capacitances of the variable capacitors C, impedance of the first LC circuit 30 and impedance of the second LC circuit 31 are adjusted.

When plasma is generated in the processing space S of the substrate processing apparatus 26 by applying a high frequency power from the high frequency power supply 22, a high frequency current flows in this processing space S. Here, since the inner shield plate 28 and the mounting table 12 are grounded via the first LC circuit 30 and the second LC circuit 31, respectively, the high frequency current in the processing space S is split into a first high frequency current 32 flowing toward the inner shield plate 28 and a second high frequency current 33 flowing toward the mounting table 12.

At this time, the magnitude of the first high frequency current 32 depends on the impedance of the first LC circuit 30, and the magnitude of the second high frequency current 33 depends on the impedance of the second LC circuit 31. Further, since a plasma density increases or decreases in proportion to a magnitude of a high frequency current, the plasma density at a peripheral portion of the processing space S depends on the first high frequency current 32, and the plasma density at the central portion of the processing space S depends on the second high frequency current 33. Accordingly, by adjusting the impedances of the first LC circuit 30 and the second LC circuit 31, the first high frequency current 32 and the second high frequency current 33 can be controlled and, as a result, a plasma density distribution in the processing space S can be controlled.

In the substrate processing apparatus 26, an impedance ratio between the first LC circuit 30 and the second LC circuit 31 is adjusted such that the first high frequency current 32 becomes larger than the second high frequency current 33. By adjusting the impedance ratio in this way, the plasma density in the processing space S can be uniformized.

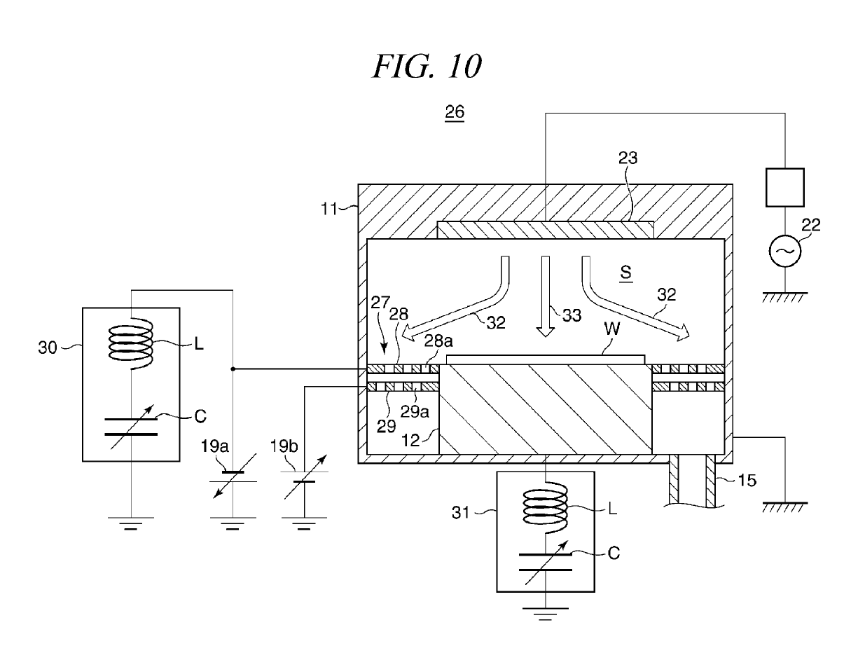

Further, as illustrated in FIG. 10, the radical filter 27, i.e., the inner shield plate 28 and the outer shield plate 29 may be disposed to surround the sidewall of the mounting table 12, serving as an exhaust plate. In this configuration, the inner shield plate 28 and the outer shield plate 29 are made of circular ring-shaped conductors and arranged to be overlapped with each other. This radical filter 27 is capable of preventing the positive ions I or the electrons E in the processing space S from entering the exhaust pipe 15. Further, by adjusting the impedances of the first and second LC circuits 30 and 31, the first high frequency current 32 and the second high frequency current 33 can be controlled, and, as a result, the plasma density distribution in the processing space S can be controlled.

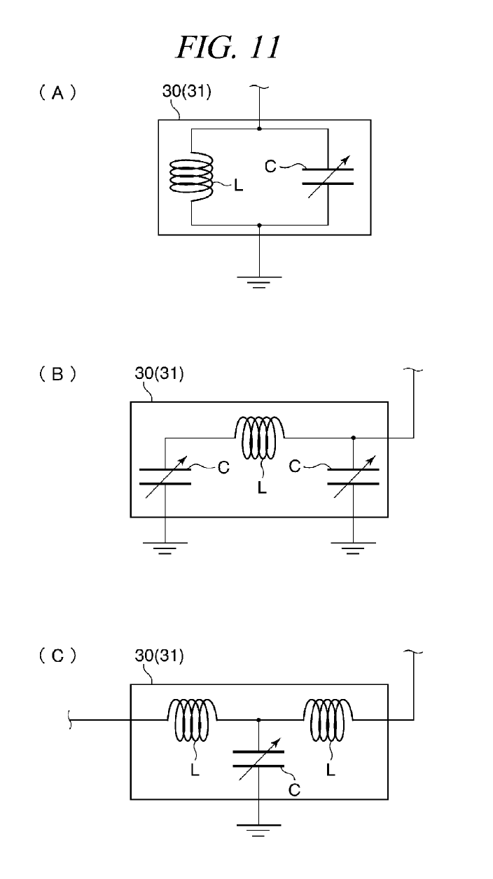

Here, each of the first LC circuit 30 and the second LC circuit 31 is not limited to the series type LC circuit in which the coil L and the variable capacitor C are connected in series. By way of non-limiting example, a parallel type LC circuit in which a coil L and a variable capacitor C are connected in parallel (see FIG. 11(A)), a n-type LC circuit in which variable capacitors C are respectively connected to both ends of a single coil L (see FIG. 11(B)), or a T-type LC circuit in which a variable capacitor C is connected to a middle point between two coils L connected in series (see FIG. 11(C)) may be used.

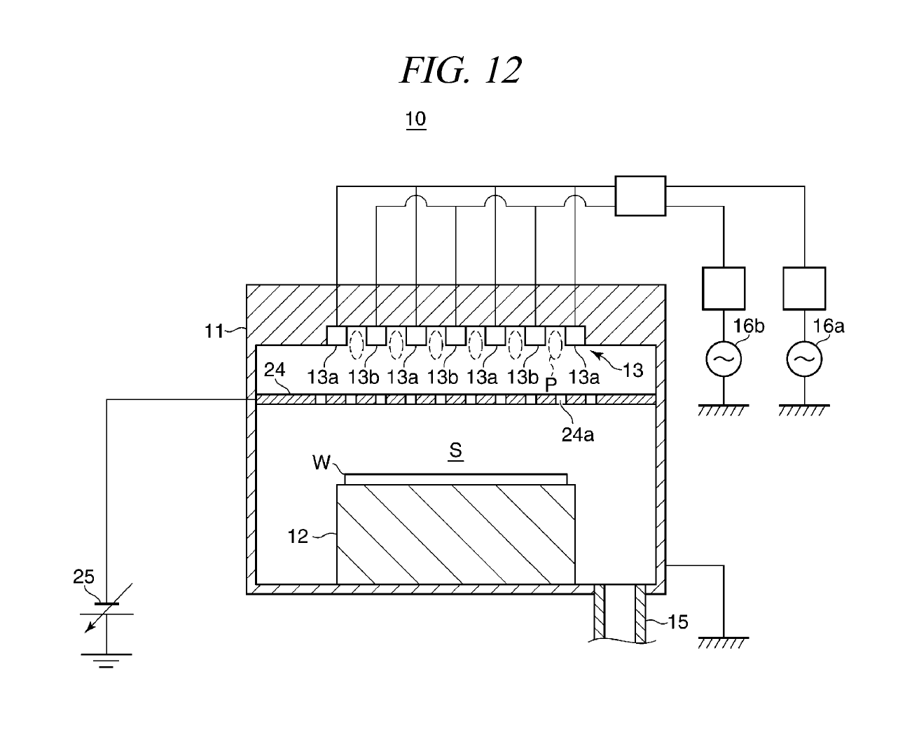

Furthermore, in the above-described substrate processing apparatus 10, the radical filter 14 selectively passes only the radicals from the plasma P by using the three effects (electrostatic force effect, sheath effect, and Lorentz effect). However, it is possible to selectively pass the radicals through the radical filter 14 by using only one of these three effects. For example, when using only the sheath effect, the radical filter 14 may have a single shield plate 24 made of a conductor such as aluminum, as illustrated in FIG. 12.

The shield plate 24 has a multiple number of through holes 24a formed in a thickness direction thereof. Further, the shield plate 24 is connected to a DC power supply 25 and a negative DC voltage is applied to the shield plate 24 from the DC power supply 25. At this time, a thick sheath is generated on the surface of the shield plate 24. If a maximum width d of each through hole 24a is set to be equal to or smaller than, e.g., about twice the thickness of the sheath generated on the surface of the shield plate 24, the through hole 24a is clogged by the sheath generated on the sidewall of the through hole 24a. Accordingly, the positive ions I or the electrons E can be prevented from passing through the through hole 24a. As a result, even with the radical filter having the single shield plate 24, it is also possible to selectively pass only the radicals.

Moreover, cross sectional shapes of the upper through holes 17a of the upper shield plate 17, the lower through holes 18a of the lower shield plate 18, and the through holes 24a of the shield plate 24 may not be particularly limited but may be of any shape such as a circle or a rectangle.

What is claimed is:

1. A radical passing device for selectively passing radicals from plasma, the radical passing device comprising:
a first shielding plate; and
a second shielding plate positioned opposite to a plasma source with the first shielding plate therebetween,
wherein the first shielding plate has a plurality of first through holes formed in a thickness direction thereof,
the second shielding plate has a plurality of second through holes formed in a thickness direction thereof,
a first DC voltage is applied to the first shielding plate and a second DC voltage is applied to the second shielding plate, and
a polarity of the first DC voltage is different from a polarity of the second DC voltage.

2. The radical passing device of claim 1,
wherein the first shielding plate and the second shielding plate are arranged such that the second through holes are not seen through the first through holes when viewed from the first shielding plate.

3. The radical passing device of claim 1,
wherein a maximum width of each through hole is set to be equal to or smaller than about twice a thickness of a sheath generated on a surface of the first shielding plate.

4. The radical passing device of claim 1,
wherein the polarity of the first DC voltage and the polarity of the second DC voltage are variable.

5. The radical passing device of claim 1,
wherein the polarity of the first DC voltage is negative.

6. The radical passing device of claim 5,
wherein the first shielding plate and an electrode plate to which a high frequency power is applied are arranged in parallel with each other to serve as a pair of parallel plate electrodes.

7. The radical passing device of claim 1,
wherein the radical passing device is provided to surround a processing space between the plasma source and a mounting table for mounting thereon a substrate.

8. A substrate processing apparatus having a chamber for accommodating therein a substrate on which a plasma process is performed; a plasma source; and a radical passing device that is provided in the chamber and selectively passes radicals from plasma,
wherein the radical passing device includes a first shielding plate provided between the plasma source and the substrate; and a second shielding plate positioned opposite to the plasma source with the first shielding plate therebetween,
the first shielding plate has a plurality of first through holes formed in a thickness direction thereof,
the second shielding plate has a plurality of second through holes formed in a thickness direction thereof,
a first DC voltage is applied to the first shielding plate and a second DC voltage is applied to the second shielding plate, and
a polarity of the first DC voltage is different from a polarity of the second DC voltage.

9. A substrate processing apparatus having a chamber for accommodating therein a substrate on which a plasma process is performed; a mounting table that is provided in the chamber, mounts thereon the substrate and serves as an electrode; and a facing electrode that is disposed in the chamber to face the mounting table and connected to a high frequency power supply; the substrate processing apparatus comprising:
a first shielding plate facing a processing space between the mounting table and the facing electrode; and
a second shielding plate disposed opposite to the processing space with the first shielding plate therebetween,
wherein the first shielding plate has a plurality of first through holes formed in a thickness direction thereof,
the second shielding plate has a plurality of second through holes formed in a thickness direction thereof,
a first DC voltage is applied to the first shielding plate and a second DC voltage is applied to the second shielding plate,
a polarity of the first DC voltage is different from a polarity of the second DC voltage,
the first shielding plate is connected to a first impedance adjusting circuit and the mounting table is connected to a second impedance adjusting circuit, and
when a high frequency current caused by a high frequency power applied from the high frequency power supply flows in the processing space, the first impedance adjusting circuit controls the high frequency current flowing toward the first shielding plate and the second impedance adjusting circuit controls the high frequency current flowing toward the mounting table.

10. The substrate processing apparatus of claim 9,
wherein the first shielding plate and the second shielding plate are arranged to surround the processing space.
